(19) United States
(12) Patent Application Publication
(10) Pub. No.: US 2020/0246997 A1
(43) Pub. Date: Aug. 6, 2020

(54) KNIFE STRIP, CUTTING BAR AND ADJUSTING DEVICE FOR THE SIMPLIFIED ADJUSTMENT OF THE KNIFE HEIGHT

(71) Applicant: manroland Goss web systems GmbH, Augsburg (DE)

(72) Inventors: THEO KEILHAU, Neusäß (DE); ERICH STÖCKLE, Donauwörth (DE); THOMAS EISENSTEGER, Augsburg (DE)

(73) Assignee: manroland Goss web systems GmbH, Augsburg (DE)

(21) Appl. No.: 16/777,740

(22) Filed: Jan. 30, 2020

(30) Foreign Application Priority Data
Jan. 31, 2019 (DE) 10 2019 102 477.3

(51) Int. Cl. B26D 7/26; B26D 1/40

(52) U.S. Cl. CPC B26D 7/2628; B26D 1/405; B26D 7/2614

(57) ABSTRACT

A knife strip, cutting bar and adjusting device are provided by means of which an exact adjustment of the knife height is ensured for the entire service life of the adjusting device or of the knife bar, or by means of which the use of an adjusting device can even be forgone completely. An adjusting device includes a knife strip wherein at least one stop surface is formed in the area of at least one outer edge. An adjusting device includes at least one stop against which the at least one stop surface of the knife strip is placed. A knife bar includes at least one stop against which the at least one stop surface of the knife strip is placed.

### FIELD OF THE INVENTION

On the one hand, the invention relates to a knife strip for generating cutting and/or perforating lines transversely to the transport direction of web-shaped or sheet-shaped substrates, comprising a knife strip length, which is defined by two outer edges, wherein at least one longitudinal edge is formed as cutting edge, as well as to an adjusting device for adjusting the exact position of the knife strip, which is arranged so as to be capable of being clamped in a knife bar, wherein the knife bar can be attached to position the knife strip into the adjusting device, as well as a knife bar for adjusting the exact position of the knife strip, which is arranged so as to be capable of being clamped in this knife bar.

### BACKGROUND OF THE INVENTION AND RELATED ART

In particular in the case of apparatuses, such as cross-cutting devices and/or folding units of web-fed printing presses for cross cutting and/or for perforating in particular web-shaped materials, such as, for example, paper webs, nonwoven webs or plastic webs, transversely to the direction of travel, so-called cutting knife or perforating knife cylinders are used, which rotate around an axis of rotation, wherein the axis of rotation is perpendicular to the transport direction of the web-shaped or sheet-shaped material, which is guided past the cutting or perforating cylinder, so that the circumferential direction of the cutting or perforating cylinder coincides with the transporting direction of the material, which is guided past. Due to the fact that it is not relevant for the below-described inventive idea whether it is used for cutting or perforating cylinders or knives, respectively, only the generic term of the cutting device or of the cutting process, respectively, will be used below, because the perforating is also a cutting process, albeit with interrupted cutting edge.

In a cutting cylinder of this type, which is also referred to as cutting knife cylinder, at least one knife strip is arranged on the jacket surface essentially parallel to the axis of rotation, wherein the knife strip is brought into operative connection with the material to be cut for the complete or partial severing. The knife strip is essentially a sheet metal strip of knife steel comprising a knife strip length, which is limited by two outer edges, wherein at least one longitudinal edge is formed as cutting edge, on which teeth are formed, which are located next to one another. The cutting edge or the teeth, respectively, are ground in on one side and are thus extremely sharp-edged.

To build up the corresponding cutting force for passing through the material to be cut, the knife strip cooperates with a counter strip, which consists mainly of an elastic material, such as, for example, foamed or unfoamed polyurethane. The at least one counter strip is fastened to a counter cylinder, which is located opposite the cutting cylinder, based on the material to be cut.

Due to the limited service life of the knife strip, the knife strip has to be capable of being exchanged with simple means on the cutting cylinder, which is why the knife strip is mostly clamped into a knife bar, which can be fastened to the cutting cylinder. The knife bar essentially consists of a base body and a clamping strip, which can be clamped thereto, wherein the knife strip is fixed between the base body and the clamping strip. To exchange the knife strip, only the at least one knife bar has to thus be exchanged on the cutting cylinder.

To ensure a clean severing of the material to be cut as well as to avoid excessive cutting or counter forces, respectively, between the knife strip and the counter strip, an exact adjustment of the knife strip to the cutting cylinder and, due to the defined contact surfaces between knife bar and cutting cylinder, an exact adjustment of the knife strip to the knife bar is thus imperative.

Adjusting devices, into which the knife bar is mostly inserted with the preassembled knife strip, are known from the prior art for this purpose. To adjust the correct knife height, that is, the correct projection of the cutting edge over the base body of the knife bar, or the correct distance of the cutting edge to the bearing surface of the knife bar in the knife cylinder, the cutting edge is pressed against a surface with defined position to the knife bar, and the knife strip is subsequently clamped in the knife bar.

An adjustment of this type has various disadvantages. If the adjusting surface, with which the cutting edge is brought into contact for the adjustment, consists of a relatively hard material, such as, for example, steel, the mostly very sharp-edged cutting edge or the very sharp teeth of the cutting edge, respectively, are already damaged, before they are even inserted into the knife cylinder. If the adjusting surface consists of a very soft material, such as, for example, an elastomer, an exact adjustment of the cutting knife height is not ensured due to the low hardness of the adjusting surface and the pass-through of the cutting edge therein. If the adjusting surface consists of a material of average hardness, such as, for example, a dimensionally stable plastic or aluminum, the area of the adjusting surface, which comes into contact with the cutting edge, wears over time due to the teeth of the cutting edge, which are mostly ground to be very sharp-edged, so that the accuracy of the knife height decreases over time.

### OBJECT AND SUMMARY OF THE INVENTION

The invention is thus based on the object of creating a solution, by means of which an exact adjustment of the knife height is ensured for the entire service life of the adjusting device or of the knife bar, or by means of which the use of an adjusting device can even be forgone completely.

The object is solved by means of a device according to the invention, which comprises a knife strip, in the case of which at least one stop surface is formed in the area of at least one outer edge, as well as an adjusting device, which comprises at least one stop, against which at least one stop surface of the knife strip can be placed, as well as a knife bar, which comprises at least one stop, against which at least one stop surface of the knife strip can be placed.

An embodiment of the cutting strip in interaction with a corresponding adjusting device or a corresponding knife bar has the advantage that, for adjusting the knife strip, the latter no longer comes into contact with a different object, so that, on the one hand, there is no longer the risk of the loss of the sharpness of the cutting edge or of the teeth molded there, respectively. On the other hand, an additional adjusting device is also no longer required when using a corresponding knife bar according to the invention, which significantly facilitates the performance of an exchange of the knife strip as well as the adjustment thereof, and which eliminates sources of error.

In an advantageous embodiment, a stop surface in each case is formed on the knife strip in the area of both outer edges or at a corresponding distance thereto, respectively. The knife strip, which is to be adjusted in the knife bar, can thus be placed with both stop surfaces against two corresponding stops of either the adjusting device or the knife bar, so that the exact positioning of the knife strip to the knife bar is ensured. The stop surfaces can thus be formed in such a way that, on the one hand, the projection of the knife strip over the knife bar is constant over the entire length, but it is also possible to design the plurality of the stop surfaces in such a way that an exact lengthwise positioning of the knife strip to the knife bar is ensured.

In a further advantageous embodiment, the at least one stop surface has a defined distance to the cutting edge. Due to the distance between the cutting edge and the at least one stop surface, as well as in particular due to a narrow tolerancing of this distance, a very exact and always constant exact positioning of the knife strip to the knife bar and thus a constantly high cut quality can thus be attained.

In a further advantageous embodiment, the at least one stop surface is embodied as a recessed notch to the cutting edge. In the case of such an embodiment, the cutting edge is thus the most raised point of the knife strip, and there is no additional interference contour, which has to be considered, in particular when the cutting cylinder cooperates with the counter cylinder, in response to the installation of the knife strip into the knife bar or in response to the installation of the knife bar into the cutting cylinder, respectively.

Further embodiments of the invention follow from the following detailed description of exemplary embodiments.

### BRIEF DESCRIPTION OF THE DRAWINGS

Various exemplary embodiments of the invention will be described in more detail hereinafter with reference to the accompanying drawings, without being limited thereto.

FIG. 1 shows a schematically illustrated knife bar, as it is known from the prior art.

FIG. 2 shows a schematically illustrated knife bar comprising a schematically illustrated adjusting device, as it is known from the prior art.

FIG. 3 shows an adjusting device according to the invention comprising a knife bar, into which a knife strip according to the invention is inserted.

FIG. 4 shows a knife bar according to the invention, into which a knife strip according to the invention is inserted.

FIG. 5 shows a knife bar according to the invention, into which a particularly advantageous knife strip according to the invention is inserted.

FIG. 6 shows a knife strip, as it is known from the prior art.

FIG. 7 shows an embodiment of a knife strip according to the invention.

FIG. 8 shows another embodiment of a knife strip according to the invention.

FIG. 9 shows another embodiment of a knife strip according to the invention.

FIG. 10 shows another embodiment of a knife strip according to the invention.

FIG. 11 shows a particularly advantageous embodiment of a knife strip according to the invention.

### DETAILED DESCRIPTION OF EMBODIMENTS OF THE INVENTION

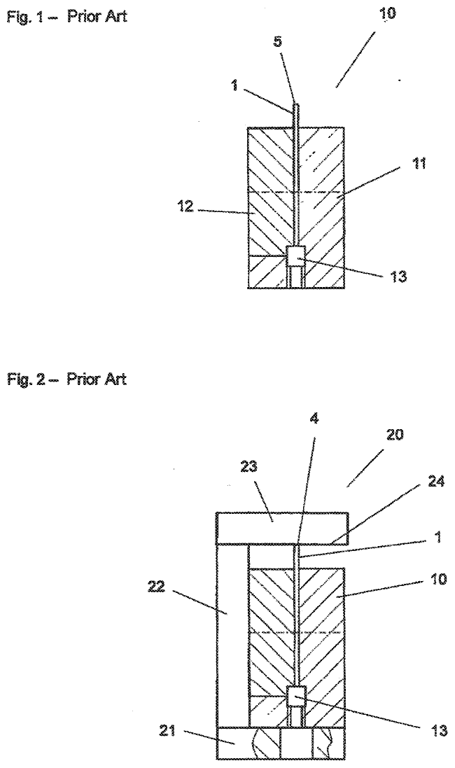

FIG. 1 shows a schematic cross section through a knife bar 10, as it is known from the prior art, and as it is used on cutting cylinders, which are also referred to as cutting knife cylinders or on perforating cylinders in cutting devices, for example for aggregates for cross cutting or cross perforating material webs, such as, for example, folding units of web-fed printing presses. The illustrated cross section is illustrated purely schematically, a corresponding knife bar 10 can also have a cross section with a different contour. The length of the knife bar 10, which extends perpendicular to the cutting plane, is a function of the point of use and the width of the printing material, which is to be cut, and usually lies in a range of approx. 200 to approx. 600 millimeters.

The knife bar 10, which is illustrated in an exemplary manner, consists of an L-shaped base body 11 and of a clamping strip 12, so that a knife strip 1 can be clamped between the base body 11 and the clamping strip 12. The clamping usually takes place via a plurality of screws, which are attached in the extension of the knife bar length and which are screwed into the base body 11 and which press the clamping strip 12, which has corresponding through bores, against the knife strip 1, so that the knife strip 1 is clamped between the base body 11 and the clamping strip 12, so as to be able to absorb the cutting forces. This screw or clamping connection, respectively, is illustrated schematically in FIG. 1 as a dash-dotted line.

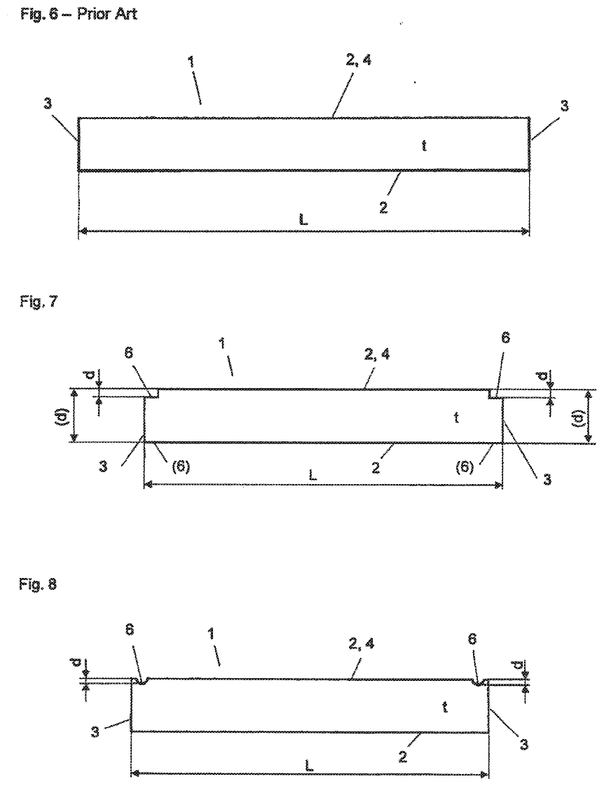

The knife strip 1, which is illustrated in FIG. 6 in an embodiment, as it is known from the prior art, usually consists of a sheet metal with a thickness of approximately 1 to approximately 2 millimeters, of correspondingly high-strength knife or spring steel, and usually has a height of approximately 30 to approximately 50 millimeters, wherein these dimensions are not relevant for the invention. The knife strip length L is usually only slightly shorter than the length of the knife bar 10, so as to ensure a clamping over the entire knife strip length L.

For the simpler adjustment of the projection of the knife strip 1 over the knife bar 10, the base body comprises at least one pressure screw 13, which presses against the knife strip 1, which is illustrated only very generally in FIG. 1.

The adjustment of the knife strip 1 in the knife carrier, as it is known from the prior art, is illustrated in an exemplary and schematic manner in FIG. 2. For this purpose, the knife bar 10 is placed into an adjusting device 20, which consists essentially of a base plate 21, a side plate 22, and a cover plate 23, the surface of which, which faces the knife bar 10, serves as an adjusting surface 24. The knife strip 1 is thereby moved in the direction of the cover plate 23 by means of the at least one pressure screw 13, until the cutting edge 4 is pressed against the adjusting surface 24 of the cover plate 23.

If the adjusting surface 24 consists of a relative hard material, such as, for example, steel, the very sharp-edged cutting edge 4 already loses sharpness, because the teeth 5, which are mostly embodied on the cutting edge 4, are only stressed pointwise. If, in contrast, the adjusting surface 24 consists of aluminum, the cutting edge 4 digs into the adjusting surface 24 over time, so that the accuracy of the adjustment of the knife strip 1 to the knife bar 10 is no longer ensured over time, because the tolerances, which need to be adhered to in response to the adjustment of the knife strip 1, are very narrow, so as to ensure a reliable and clean cut on the one hand and no excessive cutting forces on the other hand.

To avoid that the cutting edge 4 presses into the adjusting surface 24, the latter can thus also not be made of a very soft material, such as, for example, an elastomer.

Due to the contact between the cutting edge 4 and the adjusting surface 24, which cannot be avoided when using an adjusting device 20 of this type, there is the risk of damages to the cutting edge 4 already prior to the installation of the knife strip 1 or of the knife bar 10, respectively, into the cutting cylinder. A limitation of the adjusting surface 24 to at least a smaller surface does not solve this problem, but only limits it geometrically, optionally due to the higher pressure in the smaller areas with damages to the cutting edge 4, which are higher there.

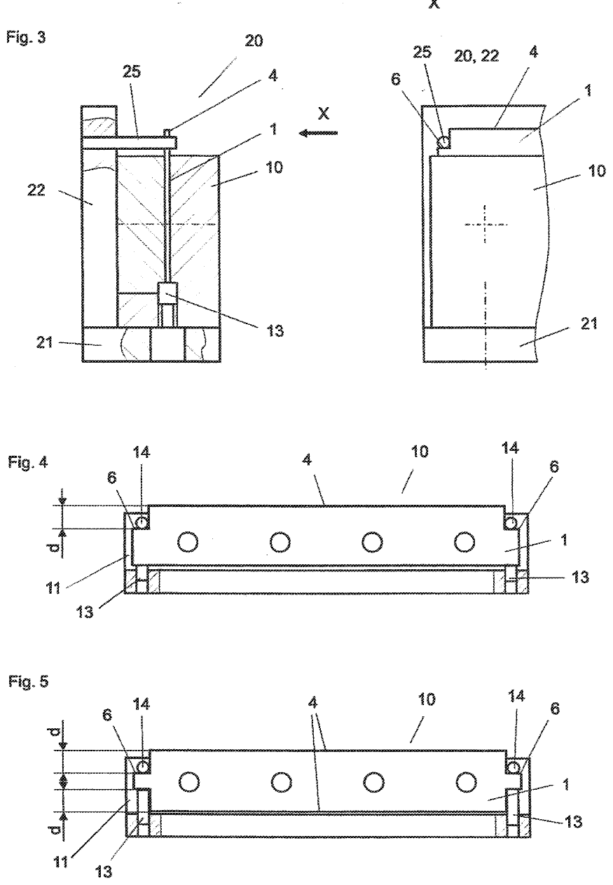

FIG. 3 shows the cross section as well as a section of the side view of an adjusting device 20 according to the invention in a schematic manner in an alternative embodiment, in the case of which for example a knife strip 1 according to the invention according to FIG. 7 is used.

The knife strip 1 is designed in such a way that at least one stop surface 6, which has a defined distance d to the cutting edge 4, is formed in the area of at least one outer edge 3, preferably in the area of both outer edges 3.

For each stop surface 6, the adjusting device 20 has a corresponding stop 25, which is attached in the side plate 22 of the adjusting device 20 in the embodiment illustrated in an exemplary manner in FIG. 3.

The knife strip 1 is attached in a clampable manner to the knife bar 10, the exemplary embodiment of a screw connection is illustrated by means of the dash-dotted lines. To position the knife strip 1 in the knife bar 10, the latter is transferred into the adjusting device 20, which comprises at least one stop 25, against which the at least one stop surface 6 of the knife strip 1 can be placed. The knife strip 1 can be pressed from below against the at least one stop 25 for example by means of the pressure screws 13. Once the correct position of the knife strip 1 is reached, that is, the at least one stop surface 6 is pressed against the stop 25, the knife strip 1 can be clamped between the base body 11 of the knife bar 10 and the clamping strip 12 by means of clamping screws, which are not illustrated in FIG. 3.

A mechanical contact of the cutting surface with a different component for adjusting the knife strip 1 is thus completely ruled out.

The embodiment of an adjusting device 20 according to the invention, which is illustrated in an exemplary manner in FIG. 3, has the advantage that existing knife bars 10 can be used therewith in connection with the knife strips 1 according to the invention.

FIG. 4 shows the front view of a knife bar 10 according to the invention, by means of which the exact position of the knife strip 1, which is arranged in a clampable manner in the knife bar 10, can also be ensured without using an additional adjusting device 20. FIG. 4 thereby shows the base body 11 of the knife bar 10 as well as the knife strip 1, which is not at least partially covered by the clamping strip 12 in this illustration, in order to be able to illustrate details of the knife strip 1 inserted therein as well as of the stops 14, which are illustrated in an exemplary manner.

The knife strip 1 is designed in such a way that at least one stop surface 6, which has a defined distance d to the cutting edge 4, is formed in the area of at least one outer edge 3, preferably in the area of both outer edges 3.

For each stop surface 6, the knife bar 10 has a corresponding stop 14, which, in the embodiment, which is illustrated in an exemplary manner in FIG. 4, is attached in the base body 11. The stop shape can thereby vary accordingly; the stop 14 can thus be embodied as a pin or can be machined directly from the material of the base body 11. The shape of the at least one stop 14 can be designed more or less arbitrarily. The at least one stop 14 can thus have, for example, planar and/or round surfaces, which are brought into contact with the at least one stop surface 6 of the knife strip 1.

Even though it is not illustrated in FIG. 4, it is also possible to reduce the distance d to a value of zero or approximately zero, so that the respective stop surface 6 of the knife strip 1 lies exactly or essentially on the same plane as the corresponding cutting surface 4.

The knife strip 1 is attached in a clampable manner in the knife bar 10, the exemplary embodiment of the clamping by means of clamping screws can be seen in that the knife strip 1 has four through bores for this purpose. To position the knife strip 1 in the knife bar 10, the latter comprises a stop 14, which is attached, for example, on the base body 11 and against which the at least one stop surface 6 of the knife strip 1 can be placed. The knife strip 1 can be pressed from below against the at least one stop 14 for example by means of the pressure screws 13. Once the correct position of the knife strip 1 is reached, that is, the at least one stop surface 6 is pressed against the stop 14, the knife strip 1 can be clamped between the base body 11 of the knife bar 10 and the clamping strip 12, which is not illustrated in FIG. 4, by means of clamping screws, which are not illustrated in FIG. 4.

Even though it is not illustrated in FIG. 4, it is obviously also possible to attach the at least one stop 14 on the side and thus on the longitudinal edge 2 of the knife strip 1, which is located opposite the cutting edge 4. To adjust the correct knife height, the knife strip 1 has to be pressed downwards against the at least one stop 14 in this case, so that additional pressure screws 13 can be forgone. Due to the fact that knife strips 1 of this type are mostly delivered with an edge protection of cut protection above the cutting edge 4, there is also no risk of injury in response to the installation of the knife strip 1 into the knife bar 10 in the case of this design. In this case, the distance d between the cutting edge 4 and the stop surface 6, which is to be adhered to exactly, would be the distance between the cutting edge 4 and the longitudinal edge 2, which is located opposite the cutting edge 4.

However, the use of stop surfaces 6, which are offset from the two longitudinal edges 2, has an additional advantage, as illustrated in FIG. 5. FIG. 5 shows a knife bar 10 according to the invention, which is virtually identical to the knife bar 10 illustrated in FIG. 4, wherein a knife strip 1 according to FIG. 11 is used in the case of the design illustrated in FIG. 5.

By using a knife strip 1, which, on at least one outer edge 3, has stop surfaces 6, which are offset accordingly on both longitudinal edges 2, the knife strip 1 can be embodied symmetrically to its longitudinal central axis, which makes it possible that both longitudinal edges 2 are embodied as cutting edges 4. If one cutting edge 4 is now worn accordingly due to the cutting process, the entire knife strip 1 does not already have to be exchanged and thus disposed of, but due to the fact that both longitudinal edges 2 are embodied as cutting edges 4, the knife strip 1 can be turned and can be used a second time, so that the required use of material and thus also the incurrence of costs is reduced.

It is irrelevant thereby whether the at least one stop 14 is arranged on the side of the cutting edge 4, which is designated for use, as it is illustrated in FIG. 5, or whether the stop 14 is arranged on the opposite side of the cutting edge 4, which is designated for use and which projects from the knife bar 10. For this purpose, the two stops 14 in FIG. 5 would need to be arranged at that location, where the pressure screw 13 is in contact with the knife strip 1 in FIG. 5. Both embodiments, namely the embodiment illustrated explicitly in FIG. 5, as well as the above-specified, only written described embodiment, nonetheless offer the advantage that a knife strip 1 comprising two cutting edges 4 can be used, as illustrated in FIG. 11.

The alternative embodiment illustrated in FIG. 5, however, in the case of which the knife strip 1 can be pressed against the at least one stop 14 by means of at least one pressure screw 13, offers the advantage that a slipping of the knife strip 1 can be ruled out when clamping the clamping strip 12 against the base body 11 of the knife bar 10 due to the ensured pressing of the at least one stop surface 6 of the knife strip 1 against the at least one stop 14 of the knife bar 10.

Even though it is not illustrated in the drawings, it is also possible to position a knife strip 1 comprising two cutting edges 4, as illustrated in an exemplary manner in FIG. 11, in a positionally accurate manner in a knife bar 10 with the help of an adjusting device 20 according to the invention, as illustrated for example in FIG. 3.

Even though it is not illustrated in FIG. 5, it is also possible to reduce the distance d to a value of zero or approximately zero, so that the respective stop surface 6 of the knife strip 1 lies exactly or essentially on the same plane as the corresponding cutting surface 4.

A mechanical contact of the cutting surface 4 with another component for adjusting the knife strip 1 is completely ruled out in all cases, in which at least one stop surface 6 of the knife strip 1 stops against at least one stop 14 of the knife bar 10 or against at least one stop 25 of the adjusting device 20, so that damages to the at least one cutting edge 4 are avoided reliably.

Only for the sake of completeness, FIG. 6 shows a knife strip 1, as it is known from the prior art. The knife strip 1 is essentially a sheet metal strip of high-strength knife or spring steel comprising a knife strip length L, which is limited by two outer edges 3. The thickness of the knife strip 1 is usually even, only in the area of the cutting edge 4, as which one of the two longitudinal edges 2 is formed, said knife strip 1 is ground in such a way on one or on both sides that a sharp cutting edge 4 for passing through the material to be cut results here. The cutting edge 4 usually has teeth 5, which are ground to be sharp, so that the knife strip 1 does not simultaneously have to pass into the material to be cut over the entire length of the cutting edge 4.

Perforating knives are embodied essentially identical to cutting knives and only have the differentiating feature that the cutting edge 4 has interruptions in terms of notches, at which the material, which is to be perforated, is to not be severed. Only the term knife strip 1 will be used below in this respect, regardless of whether they are used for cutting or for perforating materials.

FIG. 7 shows a knife strip 1 according to the invention for creating cutting and/or perforating lines transversely to the transport direction of web-shaped or sheet-shaped substrates with a knife strip length L, which is limited by two outer edges 3, wherein at least one longitudinal edge 2 is formed as a cutting edge 4, wherein teeth 5, which are usually located next to one another, are formed on the at least one cutting edge 4, and in the case of which at least one stop surface 6 is embodied in the area of at least one outer edge 3.

In the area of both outer edges 3, the knife strip 1 illustrated in FIG. 7 in each case has a stop surface 6. Each of the stop surfaces 6 has a defined and narrow tolerance distance d to the cutting edge 4, so that an exact arrangement of the cutting edge 4 to the knife bar 10 is ensured when the at least one stop surface 6 is located on the at least one stop 25 in the adjusting device 20 or the at least one stop 14 of the knife bar 10.

Even though the defined stop surfaces 6 can generally be formed at every longitudinal edge 2, they are preferably attached in the area of at least one outer edge 3, particularly preferably in the area of both outer edges 3, in order to have a clearance, which is as large as possible, in the extension of the knife strip length L, on the one hand, because this ensures an exact positioning by avoiding a tilting effect. On the other hand, the at least one cutting edge 4 can thus be formed without interruptions. It would be conceivable only in the case of perforating knifes, to embody corresponding stop surfaces 6 within the at least one cutting edge 4.

The knife strip 1 illustrated in FIG. 7 has two stop surfaces 6, which are formed as deepened notches to the cutting edge 4. This provides, for example, for an alignment of the knife strip 1 in an adjusting direction 20 as illustrated in FIG. 3, in the case of a design of this type, the knife strip 1 can further be pressed from the longitudinal edge 2, which is arranged opposite the cutting edge 4, against the stop 14, 25 by means of pressure screws 13.

As described in FIGS. 4 and 5, it is also possible, however, to form the at least one stop surface 6 on the longitudinal edge 2 located opposite the cutting edge 4, namely when the at least one stop 14, 25 on the longitudinal edge 2 located opposite the cutting edge 4 or in the area of the longitudinal edge 2, for example when they are formed as deepened notches to the longitudinal edge 2, is in operative connection. In this case, the relevant distance d, which is to be embodied in an exact manner, changes, which is why this example is also considered in FIG. 7. The bracketed distance d is to be considered in the case, in which the bracketed stop surfaces 6 are used, which, according to the example illustrated in FIG. 2, are formed as parts of the longitudinal edge 2. These stop surfaces 6, which are illustrated in brackets, can also be embodied, for example, as deepened notches in the area of the longitudinal edge 2.

Even though it is not illustrated in FIG. 7, it is also possible to reduce the distance d between the respective stop surface 6 and the cutting edge 4 to a value of zero or approximately zero, so that the respective stop surface 6 of the knife strip 1 lies exactly or essentially on the same plane as the corresponding cutting surface 4.

FIG. 8 illustrates a knife strip 1, which can essentially be compared to the knife strip 1 illustrated in FIG. 7. FIG. 8 shows another embodiment of a stop surface 6, because it is embodied as part of a circular arc. However, the embodiment illustrated in FIG. 8 with two notches in the shape of segments of a circle is only exemplary. The stop surfaces 6 in the shape of segments of a circle illustrated in FIG. 8 can thus also be arranged on the longitudinal edge 2 located opposite the cutting edge 4. It is also possible, however, to notch at least one of the corners in the shape of a circular arc. However, mixed shapes are also possible, in the case of which the at least one stop surface 6 is at least partially embodied as a circular arc. It is advantageous thereby that, when using round stops 14, 25, the knife strip 1 is not only in pointwise, but in planar contact with the stop surface 6.

FIG. 9 shows an exemplary embodiment of a knife strip 1, in the case of which the at least one stop surface 6 is embodied as a surface of an aperture 7. The surface facing the relevant cutting edge 4 can thereby be formed as stop surface 6 and/or the surface facing away from the relevant cutting edge 4 can be embodied as stop surface 6. The distance d, which is to be dimensioned exactly, is a function of the relevant stop surface 6, which is why the corresponding stop surfaces 6 and the corresponding distances d are illustrated with and without brackets in FIG. 9, wherein the reference numerals illustrated in brackets belong together and the reference numerals, which are illustrated without brackets, belong together. It is also possible to embody at least one aperture 7 as a circular bore, in particular because an optimal cooperation with a cylindrical or at least partially cylindrical stop 14, 15 is ensured in this case.

Due to the arrangement of the at least one stop surface 6 inside the knife strip 1, each of the two longitudinal edges 2 can thus be formed as cutting edge 4. This provides for the turning of the knife strip 1 in the case of corresponding wear of the first cutting edge 4. To provide for an assembly of the knife strip 1 in turned and/or rotated form in the knife bar 10, so that the second cutting edge 4 can also be used, the at least one aperture 7 is to preferably be designed to be symmetrical to a symmetry line, which is parallel and/or perpendicular to the cutting edge 4. The at least one aperture 7 must no longer be arranged very close to an outer edge 3 in this case, but to attain an exact alignment, it is advantageous to embody at least two apertures 7 with a largest possible distance in the extension of the knife strip length L.

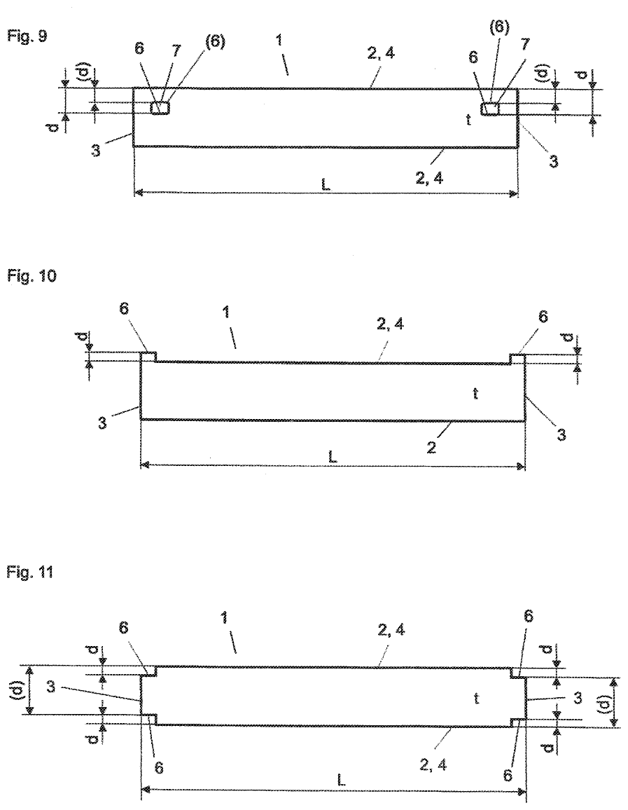

FIG. 10 shows a knife strip 1 in an exemplary manner, in the case of which the at least one stop surface 6 is raised with respect to the cutting edge 4, that is, projects over the cutting edge 4. A design of this type is only possible when the width of the material to be cut is sufficiently smaller than the length of the cutting edge 4, and the at least one raised stop surface 6 does not cause a collision with other components when being used in the corresponding cutting or perforating module.

Even though it is not illustrated in FIG. 10, it is also possible to reduce the distance d between the respective stop surface 6 and the cutting edge 4 to a value of zero or approximately zero, so that the respective stop surface 6 of the knife strip 1 is located exactly or essentially on the same plane as the corresponding cutting surface 4.

FIG. 11 shows a further exemplary embodiment of a knife strip 1, in the case of which each longitudinal edge 2 is embodied as cutting edge 4. In the example illustrated in FIG. 11, all corners between the two longitudinal edges 2, which are embodied as cutting edges 4, and the outer edges 3 are embodied as deepened notches for forming a stop surface 6 each. It is also possible in this case to bring the stop 14, 25 of the adjusting device 20 or of the knife bar 10 in contact with the stop surface 6, either on the side of the cutting edge 4 protruding from the knife carrier or on the opposite cutting edge 4. As distance d, which is to be adhered to exactly, the measured d with or without bracket are relevant as a function of the placement of the at least one stop 14, 25. A knife strip 1 of this type has the advantage that, in the case of wear of the first cutting edge 4, which is in use, the knife strip 1 does not have to be disposed of, but that it can be mounted into the knife bar 10 so as to be turned and/or rotated, so that the second cutting edge 4 located opposite the first cutting edge 4 can be used, until the knife strip 1 has to be disposed of.

Even though the knife strip 1 illustrated in FIG. 11 has stop surfaces 6, which are embodied as deepened notches, the stop surfaces 6 can also have any desired shape, in particular any of the aforementioned shapes, such as, for example notches in the shape of a circular arc.

In the case of all knife strips 1 according to the invention, it is further possible to combine different shapes of stop surfaces 6. Due to the plurality of the options, a conclusive enumeration is thus forgone.

That which is claimed:

1. A knife strip for generating cutting and/or perforating lines transversely to the transport direction of web-shaped or sheet-shaped substrates, comprising a knife strip length, which is defined by two outer edges, wherein at least one longitudinal edge is formed as a cutting edge, and wherein at least one stop surface is formed in the area of at least one of the two outer edges.

2. The knife strip according to claim 1, wherein the at least one stop surface is formed in the area of both of the two outer edges.

3. The knife strip according to claim 1, wherein the at least one stop surface has a defined distance to the cutting edge.

4. The knife strip according to claim 1, wherein the at least one stop surface is formed as a recessed notch to the cutting edge.

5. The knife strip according to claim 4, wherein the at least one stop surface is at least partially formed as a circular arc.

6. The knife strip according to claim 1, wherein the at least one stop surface is raised from the cutting edge with respect to the cutting edge.

7. The knife strip according to claim 1, wherein the at least one stop surface is formed as a surface of an aperture.

8. The knife strip according to claim 1, wherein the at least one longitudinal edge comprises two longitudinal edges, and wherein each of the two longitudinal edges is formed as the cutting edge.

9. An adjusting device for adjusting the position of a knife strip arranged to be clamped in a knife bar, wherein the knife bar is attached to position the knife strip into the adjusting device, wherein the adjusting device comprises at least one stop against which at least one stop surface of the knife strip is placed.

10. A knife bar for adjusting the position of a knife strip arranged to be clamped in the knife bar, wherein the knife bar comprises at least one stop against which at least one stop surface of the knife strip is placed.
